(19) United States
(12) Patent Application Publication
(10) Pub. No.: US 2015/0178690 A1
(43) Pub. Date: Jun. 25, 2015

(54) METHODS AND APPARATUS FOR MANAGING HIERARCHICAL CALENDER EVENTS

(71) Applicants: Darrell Reginald May, Waterloo (CA); Andrew John Ewanchuk, Baden (CA); Graham Russell, Cambridge (CA)

(72) Inventors: Darrell Reginald May, Waterloo (CA); Andrew John Ewanchuk, Baden (CA); Graham Russell, Cambridge (CA)

(21) Appl. No.: 14/418,845

(22) PCT Filed: Aug. 2, 2012
(86) PCT No.: PCT/CA2012/050524

§ 371 Date: Jan. 30, 2015

(51) Int. Cl. G06Q 10/10

(52) U.S. Cl. CPC G06Q 10/1095

(57) ABSTRACT

An example disclosed method involves associating a second calendar event with a first calendar event as a hierarchical child of the first calendar event, and displaying the first and second calendar events at date and time locations on the same calendar view of a calendar program.

### FIELD OF THE DISCLOSURE

The present disclosure relates generally to electronic devices and, more particularly, to methods and apparatus to manage hierarchical calendar events on electronic devices.

### BACKGROUND

Electronic calendar applications on electronic devices manage (e.g., generate and store) data of calendar events using flat models. Such calendar events are stand-alone records without any coded relationships to adjacent events. If adjacent calendar events are related to one another, a user must mentally or manually keep note of such relationship. Some prior calendar applications allow storing an event as a recurring event that occurs at a user-selected periodicity (e.g., once-per-week, once-per-month, etc.). For example, a user may generate a calendar event of a one-hour fitness class that recurs every Monday from noon to 1:00 pm. The recurring events have the same common description (e.g., all events represent the same one-hour fitness class) and are scheduled at a user-selected periodicity of recurrence.

### BRIEF DESCRIPTION OF THE DRAWINGS

FIG. 1 illustrates an example graphical user interface (GUI) of an electronic calendar view showing an example hierarchical multi-event group of calendar events.

FIG. 2 illustrates an expanded view of the example hierarchical multi-event group of FIG. 1.

FIG. 3 illustrates a partially expanded view of the example hierarchical multi-event group of FIG. 1 in which multiple scheduled events of the example hierarchical multi-event group are arranged on the same electronic calendar view for simultaneous viewing.

FIG. 4 illustrates another partially expanded view of the example hierarchical multi-event group of FIGS. 1 and 2 in which additional scheduled events of the example hierarchical multi-event group are arranged on the same electronic calendar view for simultaneous viewing.

FIG. 5 illustrates an alternative partially expanded view of the multi-event group of FIGS. 1 and 2 in which scheduled child events of the example hierarchical multi-event group are shown within a parent event, and grandchild events are shown horizontally adjacent to a corresponding higher-level child event.

FIG. 6 is an example manner of adding a calendar event to the hierarchical multi-event group of FIGS. 1 and 2 based on a multi-event group identifier.

FIG. 7 is an example manner of creating a recurrence of the hierarchical multi-event group of FIGS. 1 and 2.

FIG. 8 illustrates an example apparatus that may be used to implement example techniques for creating, storing, and displaying hierarchical multi-event groups disclosed herein.

FIG. 9 illustrates an example block diagram of an architecture that may be used to implement the example apparatus of FIG. 8 to generate and manage hierarchical multi-event groups of calendar events.

FIGS. 10A and 10B depict an example flow diagram representative of computer readable instructions that may be used to implement the example apparatus of FIG. 8 to generate and manage hierarchical multi-event groups of calendar events.

### DETAILED DESCRIPTION

Although the following discloses example methods, apparatus, and articles of manufacture including, among other components, software executed on hardware, it should be noted that such methods, apparatus, and articles of manufacture are merely illustrative and should not be considered as limiting. For example, any or all of these components could be embodied exclusively in hardware, exclusively in software, exclusively in firmware, or in any combination of hardware, software, and/or firmware. Accordingly, while the following describes example methods, apparatus, and articles of manufacture, persons having ordinary skill in the art will readily appreciate that the examples provided are not the only way to implement such methods, apparatus, and articles of manufacture.

It will be appreciated that, for simplicity and clarity of illustration, where considered appropriate, reference numerals may be repeated among the figures to indicate corresponding or analogous elements. In addition, numerous specific details are set forth in order to provide a thorough understanding of examples disclosed herein. However, it will be understood by those of ordinary skill in the art that examples disclosed herein may be practiced without these specific details. In other instances, well-known methods, procedures and components have not been described in detail so as not to obscure examples disclosed herein. Also, the description is not to be considered as limiting the scope of examples disclosed herein.

Example methods, apparatus, and articles of manufacture are disclosed herein in connection with electronic devices, which may be any communication device, computing device, or any other element, entity, device, or service capable of communicating wirelessly. Electronic devices may include terminals, wireless terminals, mobile stations, communication stations, user equipment (UE), mobile smart phones (e.g., BlackBerry® smart phones), wireless personal digital assistants (PDA), tablet/laptop/notebook/netbook computers with wireless adapters, etc. In some examples, disclosed example methods, apparatus, and articles of manufacture may be implemented in connection with Bluetooth® wireless communication technologies, the wireless local area network (WLAN) communication standard known as IEEE® 802.11, ZIGBEE® radio technology, wireless USB radio technology, and ultra-wideband (UWB) radio technology, or any other WLAN standards or personal area network (PAN) standards.

Examples disclosed herein may be implemented using electronic calendar applications executed by portable electronic devices (e.g., wireless communication devices, smart phones, dedicated e-book reader devices, personal digital assistants (PDAs), tablets, etc.) and/or stationary personal computers. In some instances, examples disclosed herein may also be implemented using Internet-based or web-based calendar services in which users access their calendars and associated calendar event data from cloud-based data stores or other forms of Internet-accessible data stores.

Example methods, apparatus, and articles of manufacture disclosed herein may be used to organize calendar event records (also referred to herein as calendar events) into hierarchical multi-event groups in which separate calendar events are linked together or otherwise configured to be in association with one another according to a hierarchical organization of parent events (or main events) and children events (or sub-events). For example, a full-day event or multi-day event such as a trip, a business conference, or a sports tournament event typically has associated sub-events that occur during and which constitute the main event. For example, a business conference scheduled as a full-day or multi-day main event may have multiple hour-long training presentations or break-out sessions, and a sports tournament event has multiple matches or games between different participants or teams.

A hockey tournament is an example of a main event having numerous sub-events. In some examples, the sub-events may have further sub-events. An example hockey tournament scheduled for Friday, Saturday, and Sunday, from 8 am to 5 pm may have rounds 1 and 2 on Friday and Saturday, in which round 1 has 10 scheduled games, each game being 3 periods long. Examples disclosed herein enable or facilitate scheduling this hierarchy of the main event and sub-events as a hierarchical multi-event group of calendar events in which the Friday, Saturday, and Sunday events are grouped and displayed or presented together as distinct events on the same calendar view of an electronic calendar for viewing by users. That is, the main event “Hockey Tournament” is viewable in association with its sub-events of rounds, games, and periods on the same calendar view so that a user can see a common hierarchical relationship and temporal relationships between different events of the hockey tournament main event.

Similarly, examples disclosed herein may be used to create hierarchical multi-event groups of calendar events for trip itineraries, which may reflect route durations for different trip portions, stops, points of interests, scheduled lunches, dinners, modes of transportation, etc. Examples disclosed herein may also be used to schedule hierarchical multi-event groups of calendar events for conferences, which may include keynote speaker events, lectures, workshops, and meals. Other types of multi-event groups of calendar events may also be scheduled using examples disclosed herein.

Examples disclosed herein enable viewing calendar events of hierarchical multi-event groups as separate independent events or as logical trees with hierarchically higher events (e.g., main events or parent events) being expandable to drill down to views of sub-events. Examples disclosed herein describe or create relationships between events in a hierarchical multi-event group using metadata stored in association with the calendar events in, for example, headers, data fields of calendar events, calendar event bodies, attachments to calendar events, etc. Disclosed examples enable electronic calendars to construct logical trees for hierarchical multi-event groups as defined in their associated metadata, and enable the electronic calendars to display the multiple related events simultaneously on a single calendar view so that a user can relatively quickly and easily view hierarchical relationships and dependencies between different calendar events belonging to the same hierarchical multi-event group.

Although disclosed examples are described herein as enabling the display of related main events and sub-events of the same hierarchical multi-event group in the same calendar view for simultaneously viewing the related events, examples disclosed herein for managing (e.g., creating, storing, and presenting) hierarchical multi-event groups of calendar events may also be implemented by displaying related calendar events on separate calendar views (e.g., a main or parent event in one calendar view, and child events in a separate calendar view), while still maintaining their hierarchical relationships.

Examples disclosed herein also enable creating recurring instances of hierarchical multi-event groups, and synchronizing calendar groups of hierarchical multi-event groups across different devices and/or platforms based on, for example, metadata stored in association with the calendar events of the hierarchical multi-event groups.

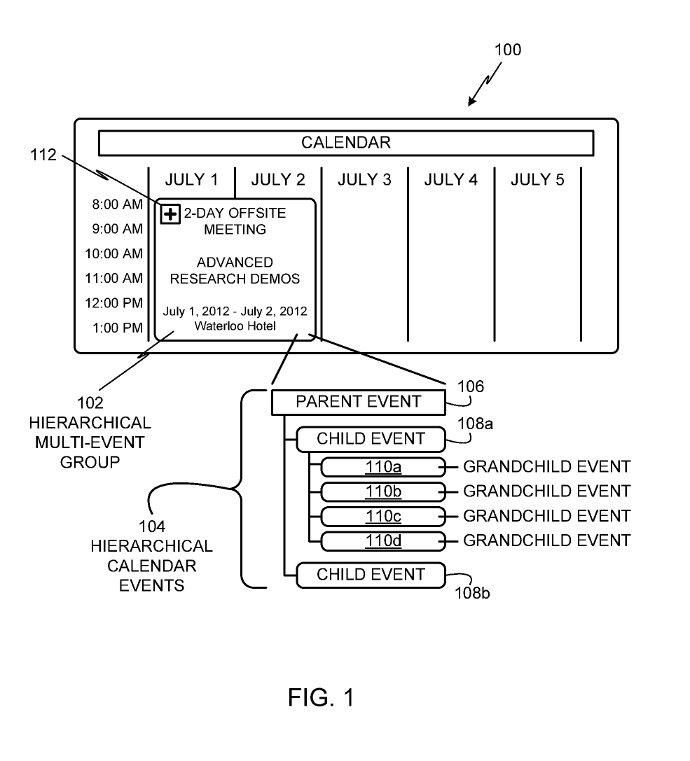

FIG. 1 illustrates an example graphical user interface (GUI) of an electronic calendar view 100 showing an example hierarchical multi-event group 102 of calendar events 104. The electronic calendar view 100 is part of a calendar program or application executed by an electronic device (e.g., a mobile device, a personal computer, a web server, etc.). In the illustrated example, the hierarchical multi-event group 102 includes a main event 106, and various events 108a-b and 110a-d that fall under, constitute or otherwise make up the main event. Hierarchical events, such as the events 106, 108a-b, and 110a-d, are described herein as having parent, child, and grandchild hierarchical relationships. Such terminology is used herein in a relative manner based on related events. For example, the parent event 106 is a parent to the child events 108a-b, and it is a grandparent to the grandchild events 110a-d. While the child event 108a is a child of the parent event 106, the child event 108a is a parent to the grandchild events 110a-d. Similarly, while the grandchild events 110a-d are grandchildren of the parent event 106 of the illustrated example, the grandchild events 110a-d are child events of the corresponding child event 108a. Other terminology for referring to hierarchical members or hierarchical relatives of a group such as main events and sub-events are also used herein to refer to the relative hierarchical relationships between calendar events (e.g., the calendar events 104) of the same hierarchical multi-event group (e.g., the hierarchical multi-event group 102). For example, the parent event 106 of FIG. 1 is a main event of the hierarchical multi-event group 102, and the child events 108a-b and grandchild events 110a-d are sub-events of the main event or parent event 106. Furthermore, when the hierarchical calendar events 104 are presented or considered as a tree-type hierarchy, the parent event 106 could be referred to as a root event and the various child events 108a-b and grandchild events 110a-d could be referred to as leaf events. For example, first-level leaf events for the child events 108a-b, second-level leaf events for the grandchild events 110a-d, and so on.

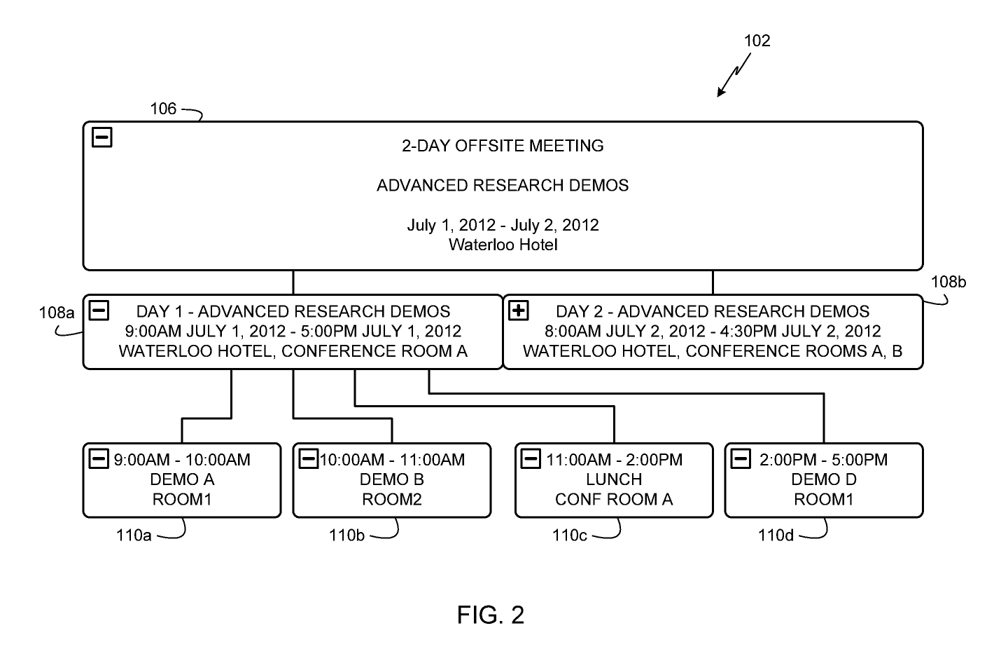

In the illustrated example, the parent event 106 is a “2-day Offsite Meeting” for “Advanced Research Demos” on “Jul. 1, 2012-Jul. 2, 2012” at the “Waterloo Hotel.” The calendar view 100 displays the parent event 106 across the two days of July 1^{st} and July 2^{nd} during which the parent event 106 is scheduled. In the illustrated example, the calendar view 100 displays a GUI expand control 112 in connection with the parent event 106 to enable a user to drill down to expanded views of the hierarchical multi-event group 102 showing sub-events (e.g., the child events 108a-b and grandchild events 110a-d) of the parent event 106. Example drill-down expanded views of the hierarchical multi-event group 102 are shown in FIGS. 2-5.

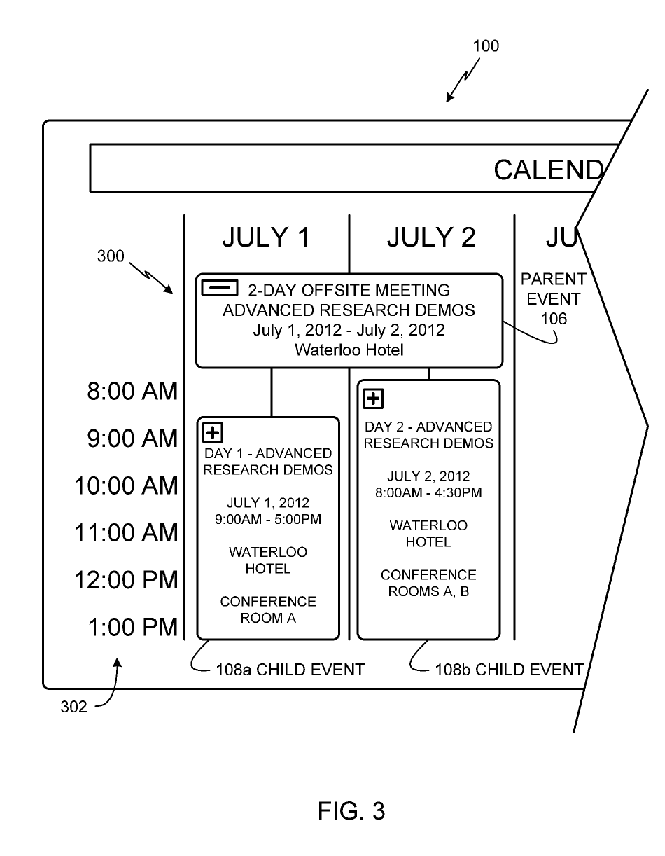

FIG. 2 illustrates an example expanded view of the example hierarchical multi-event group 102 of FIG. 1. The example expanded view of FIG. 2 is a partial expansion showing the parent event 106 expanded to show detailed views of the child events 108a-b, and showing the child event 108a expanded to show detailed views of the grandchild events 110a-d. In some examples, the expanded view of FIG. 2 may be displayed in the calendar view 100 of FIG. 1 so that all of the events 106, 108a-b, and 110a-d are simultaneously viewable on the same calendar view 100. Additionally or alternatively, an electronic calendar may use examples disclosed herein to display the hierarchical multi-event group 102 as shown in one or more of FIGS. 3-5.

In the illustrated example of FIG. 2, the child event 108a is scheduled to occur between 9:00 am and 5:00 pm on July 1^{st}. The grandchild events 110a-d (or child events 110a-d of the child event 108a) are scheduled as occurring within the scheduled 9:00 a-5:00 pm timeslot of the child event 108a. In particular, grandchild event 110a is scheduled for 9:00 am-10:00 am, grandchild event 110b is scheduled for 10:00 am-11:00 am, grandchild event 110c is scheduled for 11:00 am-2:00 pm, and grandchild event 110d is scheduled for 2:00 pm-5:00 pm. Although the child event 108a is scheduled during the same span of time as its sub-events 110a-d, examples disclosed herein enable displaying the child event 108a and the grandchild events 110a-d adjacent to one another on the same calendar view as occurring at the same time without being in conflict with one another. That is, prior calendar systems having events scheduled for the same timeslots show such events as conflicting with one another. Unlike such prior calendar systems, examples disclosed herein display hierarchically arranged events/sub-events scheduled for the same time on the same calendar view without showing that scheduling conflicts result from such simultaneously scheduled hierarchical events. Hierarchical events/sub-events displayed according to examples disclosed herein show lower-level hierarchical sub-events as nested events of higher-level hierarchical sub-events overlapping in time because of the nested configuration, but not conflicting.

In some examples, when a user requests to expand the child event 108b, the child event 108a and its grandchild events 110a-d slide off a display screen to the left, and sub-events (not shown) of the child event 108b are displayed for viewing by a user. The user interface of the rendering calendar application may be configured to allow a user to scroll horizontally to view different days/timelines containing other sub-events of the hierarchical multi-event group 102. Alternatively, in some examples, the child event 108a and its grandchild events 110a-d and the child event 108b and its grandchild events (not shown) are shown simultaneously on the same calendar view (e.g., the calendar view 100 of FIG. 1). In the illustrated example, a user may request a detailed view of any of the parent event 106, the child events 108a-b, and/or the grandchild events 110a-d by selecting a user-selectable option to view such details. Such user-selectable option may be in a menu, or it may be invoked by a swipe gesture or tap control on a touchscreen interface. When such a detailed view is requested, the details of calendar event information (e.g., event description, meeting location, duration, start time, end time, attendees, alarm options, recurrence options, category options, notes, dial-in conference call numbers, etc.) may be shown in a full-screen GUI view.

FIG. 3 illustrates a partially expanded view 300 of the example hierarchical multi-event group 102 of FIGS. 1 and 2 in which multiple scheduled events of the example hierarchical multi-event group 102 are arranged on the same electronic calendar view 100 for simultaneous viewing. The partially expanded view 300 of the illustrated example is a drilled down view of the parent event 106. In the illustrated example, the parent event 106 is shown at an upper position relative to an hourly timeline 302 of the calendar view 100, and the parent event 106 is expanded to show its child events 108a-b vertically offset below the parent event 106 and adjacent to corresponding times of the timeline 302.

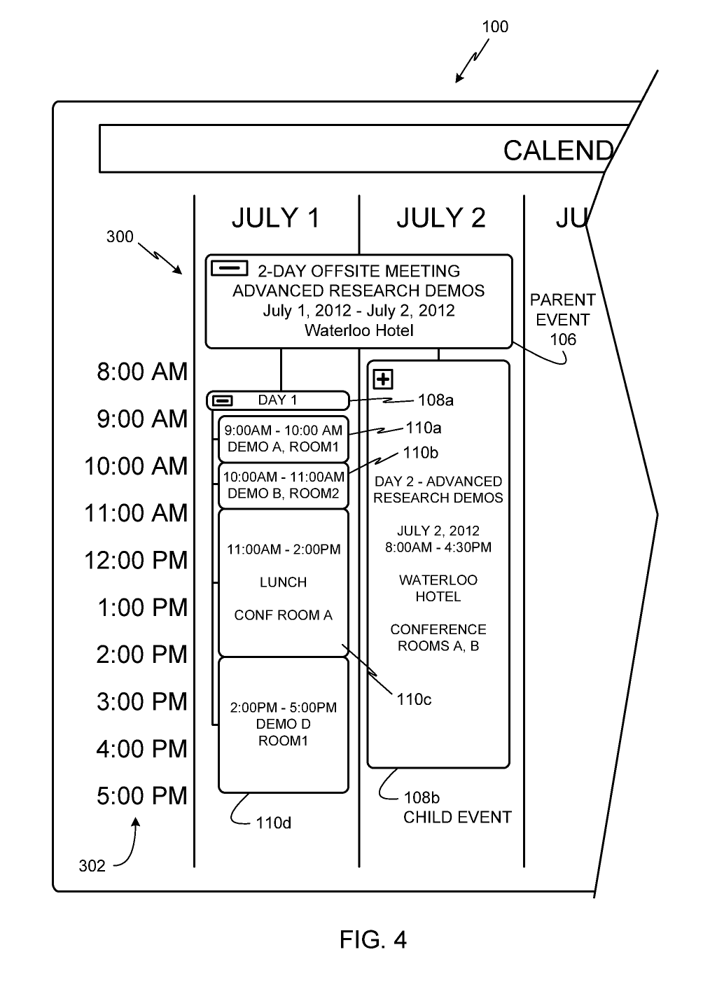

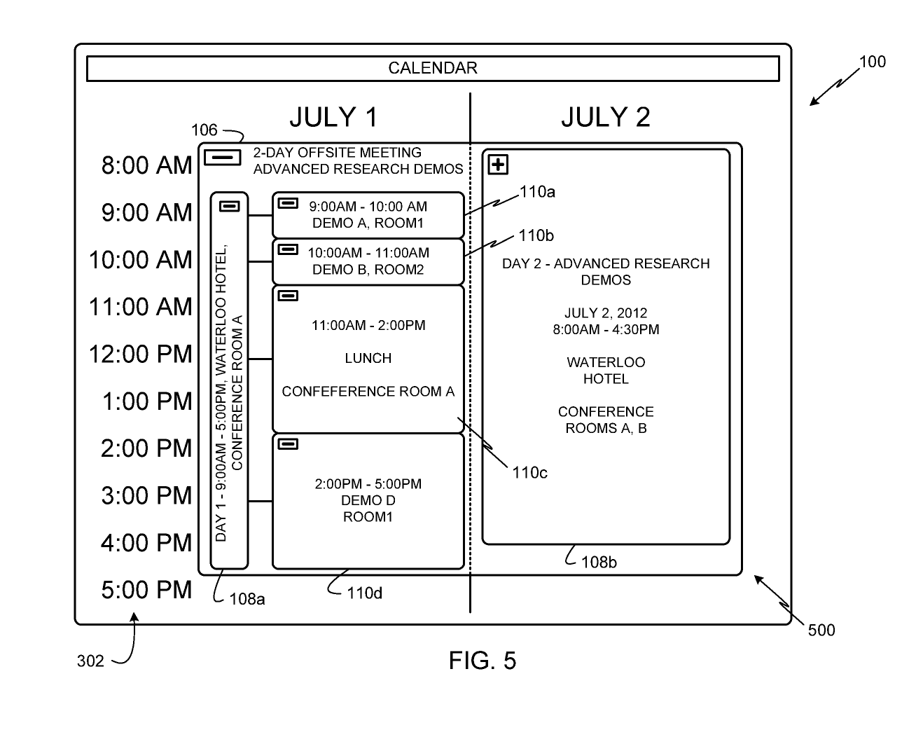

FIG. 4 illustrates another partially expanded view 400 of the example hierarchical multi-event group 102 of FIGS. 1 and 2 in which additional scheduled events of the example hierarchical multi-event group 102 are arranged on the same electronic calendar view 100 for simultaneous viewing. In the illustrated example, the calendar view 100 shows a drilled down view of the child event 108b to show the grandchild events 110a-d vertically offset from the child event 108a and adjacent to their corresponding timeslots along the timeline 302. In the illustrated examples of FIGS. 3 and 4, the events/sub-events of the hierarchical multi-event group 102 are shown displaced vertically relative to one another along the timeline 302. In other examples, events/sub-events may alternatively be shown in container/contents display configurations and/or horizontally offset from one another. Such an example is shown in FIG. 5.

FIG. 5 illustrates the calendar view 100 showing an alternative partially expanded view 500 of the multi-event group 102 of FIGS. 1 and 2 in which the parent event 102 is shown as a container including the child events 108a-b and grandchild events 110a-d as contents of the container. The partially expanded view 500 also shows the child event 108a and its corresponding grandchild events 110a-d horizontally adjacent to one another. In particular, the child event 108a occupies a span of time along the timeline 302 corresponding to its scheduled 9:00 am-5:00 pm timeslot, and the grandchild events 110a-d also occupy corresponding spans of time along the timeline 302 corresponding to their scheduled timeslots, which overlap the 9:00 am-5:00 pm timeslot of the child event 108a.

Although the calendar views 100 of FIGS. 3-5 show the parent event 106 and its sub-events 108a-b and 110a-d simultaneously along the same hourly timeline 302, the parent event 106 and sub-events 108a-b, 110a-d are not shown as conflicting with one another. Instead, lower hierarchical sub-events (e.g., the grandchild events 110a-d) are shown as events corresponding to relatively higher hierarchical events (e.g., the child event 108a and/or the parent event 106). In this manner, users can be presented with relationships and dependencies between events/sub-events of a hierarchical multi-event group of calendar events without confusingly interpreting events displayed overlapping in time as conflicting events and without having to manually or mentally keep track of which events are part of a same overall main event.

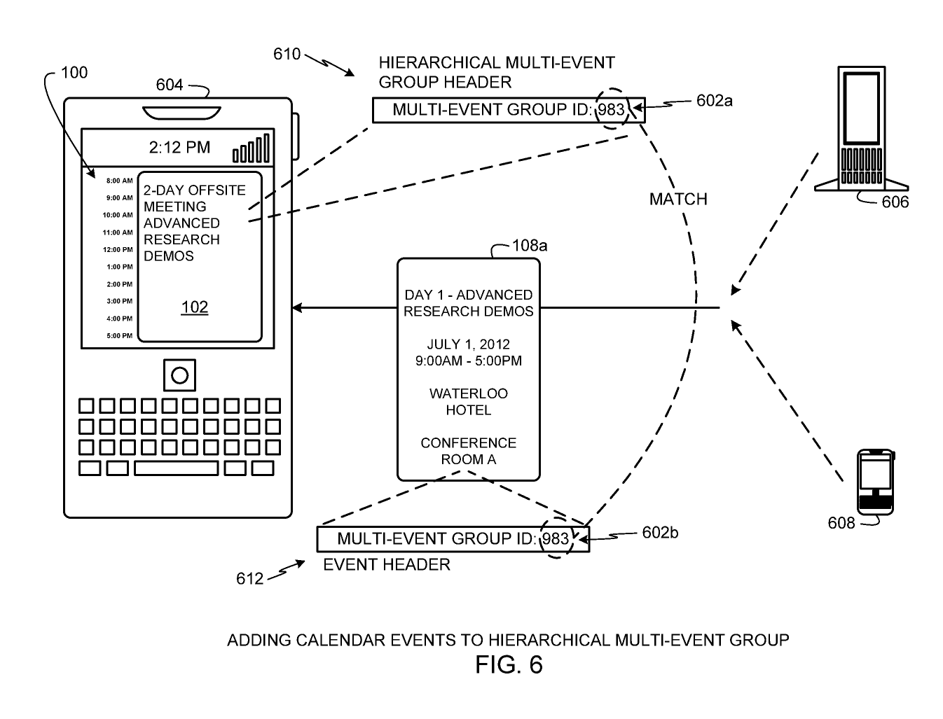

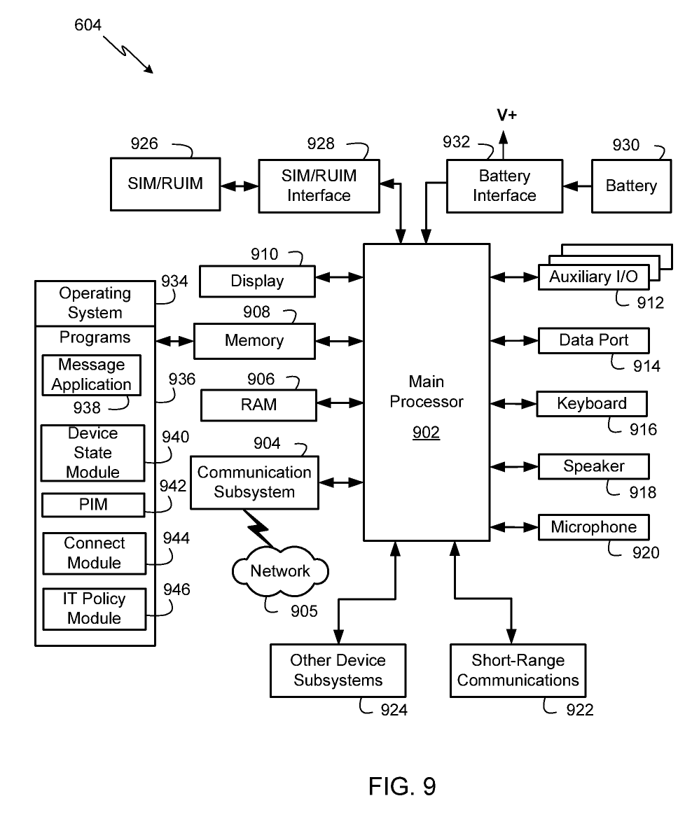

FIG. 6 is an example manner of adding a calendar event (e.g., the child event 108a of FIGS. 2-5) to the hierarchical multi-event group 102 of FIGS. 1 and 2 based on multi-event group identifiers 602a-b. In the illustrated example, an electronic device 604 initially stores the hierarchical multi-event group 102 without the child event 108a, and the electronic device 604 is shown displaying the hierarchical multi-event group 102 in the calendar view 100 of FIGS. 1 and 3-5. The illustrated example of FIG. 6 shows how the electronic device 604 can receive child events (e.g., the child event 108a of FIGS. 2-5), for example, in piecemeal fashion, to add to the hierarchical multi-event group 102 after already having the hierarchical multi-event group 102 stored therein. In some examples, the electronic device 604 may receive the child event 108a from a server 606 during a synchronization process and/or may receive the child event 108a from another device 608 as, for example, a calendar or meeting invite contained in an email message or other type of message. In either example, the electronic device 604 receives the child event 108a via a network (e.g., a cellular network, the Internet, and/or a wired or wireless local area network (LAN)) which may be, for example, the network 905 of FIG. 9.

In the illustrated example of FIG. 6, the multi-event group identifier 602a of the hierarchical multi-event group 102 is stored in a hierarchical multi-event group header 610 of or otherwise associated with the hierarchical multi-event group 102. For example, the hierarchical multi-event group header 610 may be stored in or in association with one or more calendar events of the hierarchical multi-event group 102. In addition, the child event 108a of the illustrated example includes an event header 612 that stores or contains the multi-event group identifier 602b of the child event 108a which partially constitutes the hierarchical multi-event group 102. When a calendar application of the electronic device 604 that hosts the calendar view 100 receives the child event 108a, the calendar application compares the multi-event group identifiers 602a and 602b to one another to determine whether the child event 108a should be stored as a hierarchically related event of the hierarchical multi-event group 102. In the illustrated example, the multi-event group identifiers 602a and 602b are both set to a value of “983.” As such, the calendar application of the electronic device 604 confirms a match between the multi-event group identifiers 602a and 602b, and it stores the child event 108a as a sub-event of the hierarchical multi-event group 102.

In some examples, a user may create a sub-event (e.g., the child event 108b of FIGS. 2-5) on the electronic device 604, and specify the sub-event as belonging to the hierarchical multi-event group 102. This causes the calendar application to assign the same multi-event group identifier value of “983” to the newly created child event 108b. In this manner, when the electronic device 604 communicates the child event 108b to the server 606 and/or the other device 608, the server 606 and/or the device 608 can associate the child event 108b with a hierarchical multi-event group (e.g., a copy of the hierarchical multi-event group 102) stored therein and having the same multi-event group identifier value of “983.” Although the headers 610 and 612 are shown in the illustrated example of FIG. 6, hierarchical multi-event group identifiers such as the hierarchical multi-event group identifiers 602a-b may alternatively be located in any other information fields of calendar event(s). In some examples, the hierarchical multi-event group identifiers are stored by the electronic calendar application, but are not displayed in the electronic calendar view.

In some examples, the multi-event group identifiers 602a-b may be implemented using metadata stored in the hierarchical multi-event group 102, in the events/sub-events thereof, and/or in association with the hierarchical multi-event group 102 and/or the events/sub-events. Example metadata includes header fields implemented according to Request for Comments (RFC) 2445, section 3.3, and RFC 2045. For example, multi-event group identifiers such as the multi-event group identifiers 602a-b may be embedded in header information of the iCal electronic calendaring industry standard so that hierarchical multi-event groups can be defined and shared across multiple types of software/operating system platforms and/or electronic devices.

Prior iCal standards do not define a hierarchical multi-event group parameter or attribute. Using examples disclosed herein, extensions of schema or semantics such as a new header field may be used to define a parent-child structure using, for example, header extensions permitted by RFC 2445 and RFC 2045. For example, RFC 2045, section 5.1(1) states that private values (starting with “X-”) may be defined bilaterally between two cooperating agents without outside registration or standardization. In other examples, multi-event group identifier parameters (e.g., to specify the multi-event group identifiers 602a-b) may be defined in an industry standard for use across different devices and/or calendar applications.

Example private values for defining multi-event group identifiers such as the multi-event group identifiers 602a-b may be defined as follows:
X-Event-Parent=<GUID of Parent Event|None/0 to indicate no Parent>, wherein a GUID is a global unique identifier
X-Event-Children<List of GUID's of child events, and optional time, or description so you don't have to fetch them until they are expanded|None/Absent if there are no child events>

In this manner, the X-Event-Parent parameter field can be used to specify a parent or main event (e.g., the parent event 106 of FIGS. 1-5), and the X-Event-Children parameter field can be used to specify child events or sub-events (e.g., the child events 108a-b and/or grandchild events 110a-d). In the illustrated example of FIG. 6, the X-Event-Parent parameter field of the parent event 106 corresponding to the hierarchical multi-event group 102 stores the multi-event group identifier value of “983,” and the X-Event-Children parameter field of the child event 108a also stores the multi-event group identifier value of “983” to indicate that the child event 108a is a sub-event of the parent event 106.

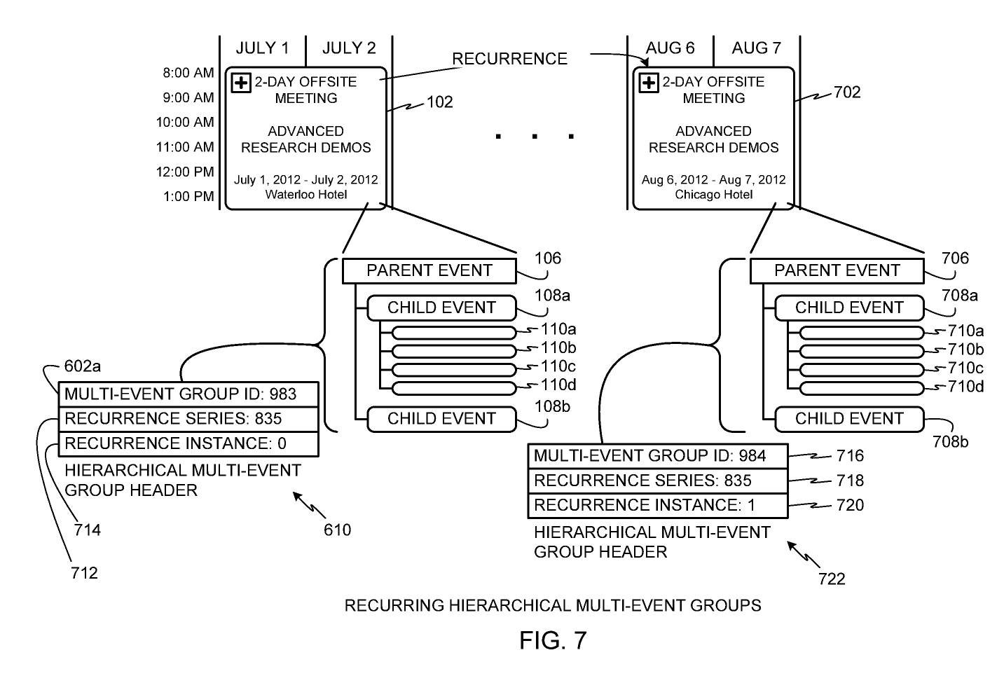

FIG. 7 is an example manner of creating a recurrence of the hierarchical multi-event group 102 of FIGS. 1, 2, and 6. In the illustrated example, the hierarchical multi-event group 102 is scheduled on July 1^{st} and July 2^{nd}, and a recurrence 702 of the hierarchical multi-event group 102 is created or scheduled on August 6^{th} and August 7^{th}. The recurrence 702 of the illustrated example includes a parent event 706, child events 708a-b, and grandchild events 710a-d. In the illustrated example, the parent event 706 is a substantial copy of the parent event 106, the child events 708a-b are substantial copies of the child events 108a-d, and the grandchild events 710a-d are substantial copies of the grandchild events 110a-d. In the illustrated example, the recurrence 702 differs from the hierarchical multi-event group 102 in the dates and location information (e.g., Chicago Hotel instead of Waterloo Hotel). Thus, when a recurrence is created, some information in the recurrence may be changed by a user. Alternatively, except for the dates all of the information may be the same between different instances of a recurring hierarchical multi-event group. In the illustrated example, a user may select dates on which the recurrence 702 is scheduled. That is examples disclosed herein do not force regular intervals (e.g., every week, every month, every year etc.) for recurrences. Although such regular intervals may be selected by a user for the recurrence 702 of the illustrated example, the illustrated example also enables the user to select a particular date or dates or a particular date offset (e.g., 3 days later, one-week later, 8 days later, etc.) on which to schedule the recurrence 702.

In the illustrated example, the hierarchical multi-event group 102 and the recurrence 702 are provided with metadata that describes their multi-event group properties and their relationships to and/or dependencies on one another. For example, the hierarchical multi-event group 102 is provided with the multi-event group identifier 602a, a recurrence series identifier 712, and a recurrence instance indicator 714. The recurrence 702 is provided with a multi-event group identifier 716, a recurrence series identifier 718, and a recurrence instance indicator 720. In the illustrated example, the values of the multi-event group identifiers 602a and 716 are set to values different from one another (“983” and “984”) so that the hierarchical multi-event group 102 and the recurrence 702 can be retrieved and modified independent of one another. The recurrence series identifiers 712 and 718 are set to the same value of “835” to identify hierarchical multi-event groups that are part of the same recurring series. In some examples, the recurrence series identifiers 712 and 718 may also be used to propagate changes made by a user to multiple instances in a recurring series when the user specifies that the change should be made to the multiple instances of the recurring series. The recurrence instance indicators 714 and 720 identify a particular instance of a corresponding recurrence (e.g., the recurrence 702) in a recurring series of hierarchical multi-event groups. In the illustrated example, the multi-event group identifier 602a, the recurrence series identifier 712, and the recurrence instance indicator 714 are stored in the hierarchical multi-event group header 610 of the hierarchical multi-event group 102. In addition, the multi-event group identifier 716, the recurrence series identifier 718, and the recurrence instance indicator 720 are stored in a hierarchical multi-event group header 722 of the recurrence 702. Although the headers 610 and 722 are shown in the illustrated example of FIG. 7, metadata or information such as the parameters 602a, 712, 714, 716, 718, and/or 720 may alternatively be located or stored elsewhere such as in any other information fields of calendar event(s). In some examples, the metadata or information such as the parameters is stored by the electronic calendar application, but are not displayed in the electronic calendar view.

In the illustrated example, when a user requests to make a single recurrence or multiple recurrences of the hierarchical multi-event group 102 (e.g., through a user-selection of a user interface control to create a recurrence or second instance of the hierarchical multi-event group 102), the user can specify how the recurrence(s) should be scheduled. For example, the user can select periodic recurrences at regular intervals for multiple recurring instances, or the user can specify a particular date or particular dates (e.g., August 6-7 of FIG. 7) when one or more recurrences should be scheduled. When a calendaring application receives the user's request (e.g., an input indicating a user-selection of a user interface control) to schedule one or more recurrences, it copies the hierarchical multi-event group 102 including all of its events and sub-events to schedule a recurrence or recurrences (e.g., the recurrence 702), and creates and stores the metadata 716, 718, and 720. In this manner, users need not individually schedule recurrences of each event and sub-event of a group. Instead, a user can create a recurring hierarchical multi-event group by selecting the group, and the calendar application handles the copying of all of the events and sub-events associated with that selected hierarchical multi-event group when scheduling the one or more recurrences.

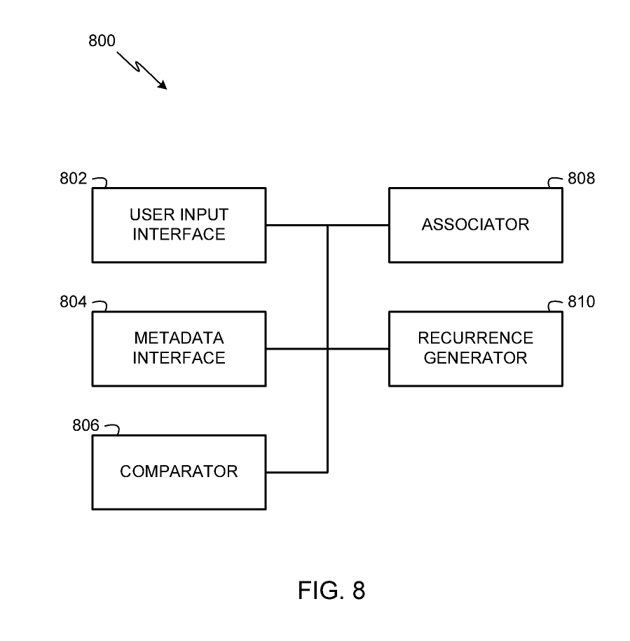

FIG. 8 illustrates an example apparatus 800 that may be used to implement example techniques for creating, storing, and displaying hierarchical multi-event groups disclosed herein. In the illustrated example of FIG. 8, the apparatus 800 includes a user input interface 802, a metadata interface 804, a comparator 806, an associator 808, and a recurrence generator 810. The user input interface 802, the metadata interface 804, the comparator 806, the associator 808, and/or the recurrence generator 810 may be implemented using any desired combination of hardware, firmware, and/or software. For example, one or more integrated circuits, discrete semiconductor components, and/or passive electronic components may be used. Thus, for example, the user input interface 802, the metadata interface 804, the comparator 806, the associator 808, and/or the recurrence generator 810, or parts thereof, could be implemented using one or more circuit(s), programmable processor(s), application specific integrated circuit(s) (ASIC(s)), programmable logic device(s) (PLD(s)), field programmable logic device(s) (FPLD(s)), field programmable gate array(s) (FPGA(s)), etc. The user input interface 802, the metadata interface 804, the comparator 806, the associator 808, and/or the recurrence generator 810, or parts thereof, may be implemented using instructions, code, and/or other software and/or firmware, etc. stored on a machine-accessible medium or computer-readable medium (e.g., a memory 908 of FIG. 9) and executable by, for example, a processor (e.g., a processor 902 of FIG. 9). When any of the appended claims are read to cover a purely software implementation, at least one of the user input interface 802, the metadata interface 804, the comparator 806, the associator 808, or the recurrence generator 810 is hereby expressly defined to include a tangible or non-transitory medium such as a solid state memory, a magnetic memory, a DVD, a CD, etc.

Turning in detail to FIG. 8, the apparatus 800 of the illustrated example includes the user input interface 802 to receive user input. The example user input interface 802 may be implemented using button interface(s), key interface(s), a touch panel interface, graphical user input interfaces, or any other type of user interface capable of receiving user input information.

The apparatus 800 of the illustrated example includes the metadata interface 804 to manage (e.g., generate, modify, read, and/or write) metadata information such as user-provided information (e.g., event description, meeting location, duration, start time, end time, attendees, alarm options, recurrence options, category options, notes, dial-in conference call numbers, etc.) to create a calendar event, the multi-event group identifier 602a of the hierarchical multi-event group header 610 of FIG. 6, the multi-event group identifier 602b of the event header 612 of FIG. 6, and/or the metadata in the hierarchical multi-event group headers 610 and 722 described above in connection with FIG. 7, and/or any other metadata or information stored in calendar events.

To compare metadata such as the multi-event group identifiers 602a-b (FIGS. 6 and 7), the recurrence series identifiers 712 and 718 (FIG. 7), etc., the apparatus 800 of the illustrated example includes the comparator 806. To associate events/sub-events with one another when they are part of the same hierarchical multi-event group (e.g., the hierarchical multi-event group 102 of FIGS. 1, 2, 6, and 7, the apparatus 800 includes the associator 808. To generate and schedule recurrences of hierarchical multi-event groups, such as the recurrence 702 (FIG. 7) of the hierarchical multi-event group 102, the example apparatus 800 includes the recurrence generator 810.

FIG. 9 illustrates a block diagram of an example architecture that may be used to implement the electronic device 604 of FIG. 6 to generate and manage hierarchical multi-event groups of calendar events in accordance with examples disclosed herein. In the illustrated example, the electronic device 604 is a two-way communication device with advanced data communication capabilities including the capability to communicate with other wireless-enabled devices or computer systems through a network of transceiver stations. The electronic device 604 may also have the capability to allow voice communication. Depending on the functionality provided by the electronic device 604, it may be referred to as a data messaging device, a two-way pager, a cellular telephone with data messaging capabilities, a smart phone, a wireless Internet appliance, or a data communication device (with or without telephony capabilities). In other examples, the architecture of FIG. 9 may be adapted to implement devices other than the electronic device 604 (e.g., a personal computer, a tablet computer, a server, etc.) to implement examples disclosed herein. To aid the reader in understanding the structure of the electronic device 604 and how it communicates with other devices and host systems, FIG. 9 will now be described in detail.

Referring to FIG. 9, the electronic device 604 includes a number of components such as a main processor 902 that controls the overall operation of the electronic device 604. Communication functions, including data and voice communications, are performed through a communication subsystem 904. The communication subsystem 904 receives messages from and sends messages to a wireless network 905, which may implement or be in communication with the server 606 and/or the device 608 of FIG. 6. In the illustrated example of the electronic device 604, the communication subsystem 904 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the example implementations described herein are intended to use any other suitable standards that are developed in the future. The wireless link connecting the communication subsystem 904 with the wireless network 905 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 905 associated with the electronic device 604 is a GSM/GPRS wireless network in one example implementation, other wireless networks may also be associated with the electronic device 604 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include WiFi 802.11, MOBITEX® and DATATAC® network communication systems. Examples of other voice-centric data networks include Personal Communication Systems (PCS) networks like GSM and Time Division Multiple Access (TDMA) systems.

The main processor 902 also interacts with additional subsystems such as a Random Access Memory (RAM) 906, a persistent memory 908 (e.g., a non-volatile memory), a display 910, an auxiliary input/output (I/O) subsystem 912, a data port 914, a keyboard 916, a speaker 918, a microphone 920, a short-range communications sub-system 922, and other device subsystems 924.

Some of the subsystems of the electronic device 604 perform communication-related functions, whereas other subsystems may provide “resident” or on-device functions. By way of example, the display 910 and the keyboard 916 may be used for both communication-related functions, such as entering calendar events or a text message or email for transmission over the network 905, and device-resident functions such as a calculator or task list.

The electronic device 604 can send and receive communication signals over the wireless network 905 after required network registration or activation procedures have been completed. Network access is associated with a subscriber or user of the electronic device 604. To identify a subscriber, the electronic device 604 requires a SIM/RUIM card 926 (i.e., Subscriber Identity Module or a Removable User Identity Module) to be inserted into a SIM/RUIM interface 928 in order to communicate with a network. The SIM card or RUIM 926 is one type of a conventional “smart card” that can be used to identify a subscriber of the electronic device 604 and to personalize the electronic device 604, among other things. The SIM card/RUIM 926 includes a processor and memory for storing information. Once the SIM card/RUIM 926 is inserted into the SIM/RUIM interface 928, it is coupled to the main processor 902. In order to identify the subscriber, the SIM card/RUIM 926 can include some user parameters such as an International Mobile Subscriber Identity (IMSI). One feature of using the SIM card/RUIM 926 is that a subscriber is not necessarily bound by any single physical electronic device. The SIM card/RUIM 926 may store additional subscriber information for an electronic device as well, including datebook (or calendar) information and recent call information. Alternatively, user identification information can also be programmed into the persistent memory 908.

The electronic device 604 is a battery-powered device and includes a battery interface 932 for receiving one or more rechargeable batteries 930. In at least some embodiments, the battery 930 can be a smart battery with an embedded microprocessor.

The electronic device 604 also includes an operating system 934 and software components 936 to 946 which are described in more detail below. The operating system 934 and the software components 936 to 946 that are executed by the main processor 902 are typically stored in a persistent store such as the persistent memory 908, which may alternatively be a read-only memory (ROM) or similar storage element (not shown). Those skilled in the art will appreciate that portions of the operating system 934 and the software components 936 to 946, such as specific device applications, or parts thereof, may be temporarily loaded into a volatile store such as the RAM 906. Other software components can also be included, as is well known to those skilled in the art.

The subset of software applications 936 that control basic device operations, including data and voice communication applications, will normally be installed on the electronic device 604 during its manufacture. Other software applications include a message application 938 that can be any suitable software program that allows a user of the electronic device 604 to send and receive electronic messages. Various alternatives exist for the message application 938 as is well known to those skilled in the art. Messages that have been sent or received by the user are typically stored in the persistent memory 908 of the electronic device 604 or some other suitable storage element in the electronic device 604. In at least some embodiments, some of the sent and received messages may be stored remotely from the electronic device 604 such as in a data store of an associated host system with which the electronic device 604 communicates.

The software applications can further include a device state module 940, a Personal Information Manager (PIM) 942, and other suitable modules (not shown). The device state module 940 provides persistence (i.e., the device state module 940 ensures that important device data is stored in persistent memory, such as the persistent memory 908, so that the data is not lost when the electronic device 604 is turned off or loses power).

The PIM 942 includes functionality for organizing and managing data items of interest to the user, such as, but not limited to, e-mail, contacts, calendar events, voice mails, appointments, and task items. A PIM application has the ability to send and receive data items via the wireless network 905. PIM data items may be seamlessly integrated, synchronized, and updated via the wireless network 905 with the electronic device subscriber's corresponding data items stored and/or associated with a host computer system. This functionality creates a mirrored host computer on the electronic device 604 with respect to such items. This can be particularly advantageous when the host computer system is the electronic device subscriber's office computer system.

The electronic device 604 also includes a connect module 944, and an IT policy module 946. The connect module 944 implements the communication protocols that are required for the electronic device 604 to communicate with the wireless infrastructure and any host system, such as an enterprise system, that the electronic device 604 is authorized to interface with.

The IT policy module 946 receives IT policy data that encodes the IT policy. The IT policy module 946 then ensures that the IT policy data is authenticated by the electronic device 604. The IT policy data can then be stored in the flash memory 906 in its native form. After the IT policy data is stored, a global notification can be sent by the IT policy module 946 to all of the applications residing on the electronic device 604. Applications for which the IT policy may be applicable then respond by reading the IT policy data to look for IT policy rules that are applicable. In at least some embodiments, the IT policy module 946 can determine which applications (e.g., calendar applications and/or other PIM applications) are affected by the IT policy data and send a notification to only those applications. After the IT policy rules have been applied to the applicable applications or configuration files, the IT policy module 946 sends an acknowledgement back to the host system to indicate that the IT policy data was received and successfully applied.

Other types of software applications can also be installed on the electronic device 604. These software applications can be third party applications, which are added after the manufacture of the electronic device 604. Examples of third party applications include games, calculators, utilities, etc.

The data port 914 enables a subscriber to set preferences through an external device or software application and extends the capabilities of the electronic device 604 by providing for information or software downloads to the electronic device 604 other than through a wireless communication network. The alternate download path may, for example, be used to load an encryption key onto the electronic device 604 through a direct and thus reliable and trusted connection to provide secure device communication.

The data port 914 can be any suitable port that enables data communication between the electronic device 604 and another computing device. The data port 914 can be a serial or a parallel port. In some instances, the data port 914 can be a USB port that includes data lines for data transfer and a supply line that can provide a charging current to charge the battery 930 of the electronic device 604.

The short-range communications subsystem 922 provides for communication between the electronic device 604 and different systems or devices, without the use of the wireless network 905. For example, the subsystem 922 may include an infrared device and associated circuits and components for short-range communication. Examples of short-range communication standards include standards developed by the Infrared Data Association (IrDA), a Bluetooth® communication standard, and the 802.11 family of standards developed by IEEE.

In use, a received signal such as a text message, an e-mail message, web page download, media content, calendar events, etc. will be processed by the communication subsystem 904 and input to the main processor 902. The main processor 902 will then process the received signal for output to the display 910 or alternatively to the auxiliary I/O subsystem 912. A subscriber may also compose data items, such as e-mail messages, for example, using the keyboard 916 in conjunction with the display 910 and possibly the auxiliary I/O subsystem 912. The auxiliary subsystem 912 may include devices such as: a touch screen, mouse, track ball, infrared fingerprint detector, or a roller wheel with dynamic button pressing capability. The keyboard 916 is preferably an alphanumeric keyboard and/or telephone-type keypad. However, other types of keyboards may also be used. A composed item may be transmitted over the wireless network 905 through the communication subsystem 904.

For voice communications, the overall operation of the electronic device 604 is substantially similar, except that the received signals are output to the speaker 918, and signals for transmission are generated by the microphone 920. Alternative voice or audio I/O subsystems, such as a voice message recording subsystem, can also be implemented on the electronic device 604. Although voice or audio signal output is accomplished primarily through the speaker 918, the display 910 can also be used to provide additional information such as the identity of a calling party, duration of a voice call, or other voice call related information.

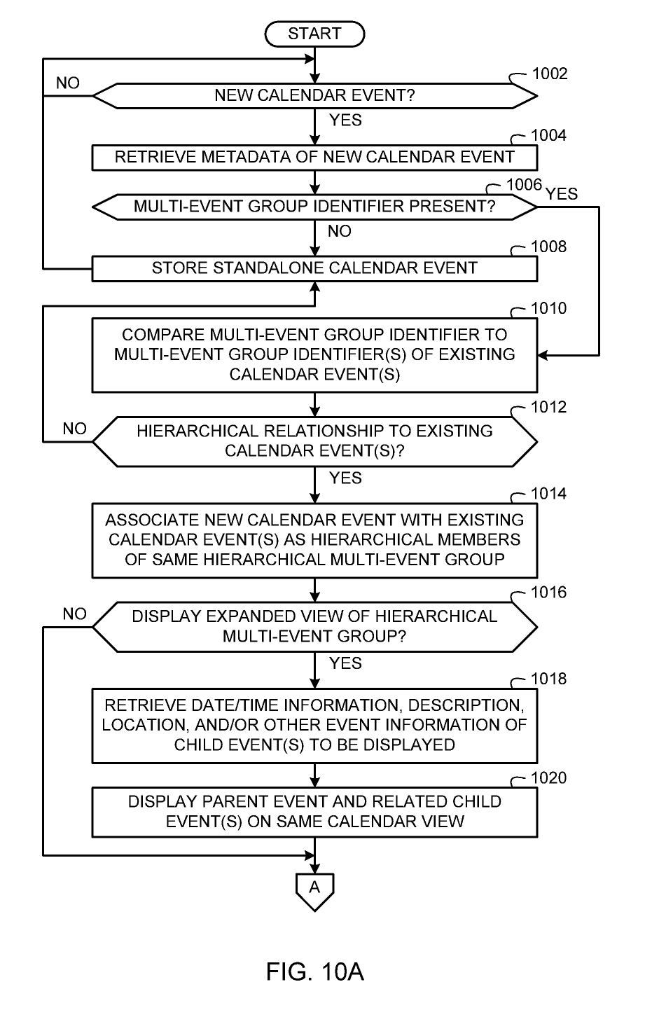

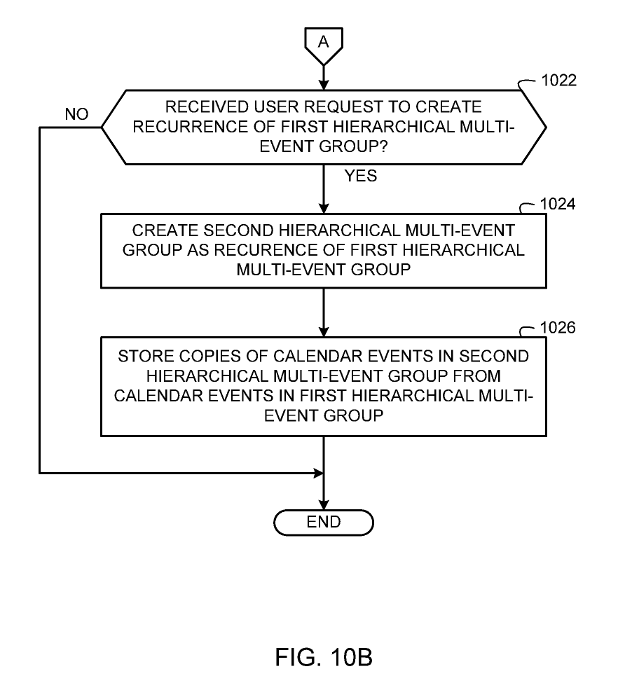

FIGS. 10A and 10B depict an example flow diagram representative of computer readable instructions that may be used to implement the example apparatus of FIG. 8 to generate and manage hierarchical multi-event groups of calendar events. The example methods of FIGS. 10A and 10B may be performed using one or more processors, controllers, and/or any other suitable processing devices. For example, the example methods of FIGS. 10A and 10B may be implemented using coded instructions (e.g., computer readable instructions) stored on one or more tangible computer readable media such as flash memory, read-only memory (ROM), and/or random-access memory (RAM). As used herein, the term tangible computer readable storage medium is expressly defined to include any type of computer readable storage and to exclude propagating signals. Additionally or alternatively, the example methods of FIGS. 10A and 10B may be implemented using coded instructions (e.g., computer readable instructions) stored on one or more non-transitory computer readable media such as flash memory, read-only memory (ROM), random-access memory (RAM), cache, or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

Alternatively, some or all operations of the example methods of FIGS. 10A and 10B may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all operations of the example methods of FIGS. 10A and 10B may be implemented manually or as any combination(s) of any of the foregoing techniques, for example, any combination of firmware, software, discrete logic and/or hardware. Further, although the example methods of FIGS. 10A and 10B are described with reference to the flow diagram of FIGS. 10A and 10B, other methods of implementing the methods of FIGS. 10A and 10B may be employed. For example, the order of execution of the blocks may be changed, and/or some of the blocks described may be changed, eliminated, sub-divided, or combined. Additionally, any or all operations of the example methods of FIGS. 10A and 10B may be performed sequentially and/or in parallel by, for example, separate processing threads, processors, devices, discrete logic, circuits, etc.

In the illustrated example, the methods of FIGS. 10A and 10B is described below as performed by the example apparatus 800 of FIG. 8 as implemented using the example electronic device 604 of FIGS. 6 and 9. However, the example methods of FIGS. 10A and 10B may additionally or alternatively be implemented using any other suitable device.

Now turning in detail to FIG. 10A, initially the processor 902 (FIG. 9) determines whether it has received a new calendar event (block 1002). For example, a new calendar event may be created by a user via the electronic device 604, and/or the electronic device 604 may receive a new calendar event from the server 606 (FIG. 6) during a synchronization process, and/or from the device 608 (FIG. 6) via an email message or other type of message. If the processor 902 does not receive a new calendar event at block 1002, it continues to monitor for a new calendar event. If the processor 902 receives a new calendar event at block 1002, the metadata interface 804 (FIG. 8) retrieves metadata of the new calendar event (block 1004). For example, if the new calendar event is the child event 108a shown in FIG. 6, the metadata interface 804 retrieves the event header 612 (FIG. 6) from the child event 108a.

The processor 902 determines whether a multi-event group identifier is present in the metadata (block 1006). For example, the processor 902 may search the event header 612 for the multi-event group identifier 602b (FIG. 6). If the multi-event group identifier is not present (block 1006), the processor 902 stores a standalone calendar event (block 1008) based on the new calendar event. Otherwise, if the multi-event group identifier is present (block 1006), the comparator 806 (FIG. 8) compares the multi-event group identifier (e.g., the multi-event group identifier 602b) to one or more multi-event group identifier(s) of one or more existing calendar events (block 1010). For example, the comparator 806 compares the multi-event group identifier 602b to the multi-event group identifier 602a of FIG. 6 to determine if they match.

If the multi-event group identifier of the new calendar event does not match a multi-event group identifier of an existing calendar event (block 1012), control is transferred to block 1008 at which the processor 902 stores a standalone calendar event having a multi-event group identifier for any future associations with later-received calendar events that have the same multi-event group identifier. If the multi-event group identifier of the new calendar event does match a multi-event group identifier of an existing calendar event (block 1012), a hierarchical relationship exists between the new calendar event (e.g., the child event 108b) and one or more existing calendar event(s) (e.g., the parent event 106 of the hierarchical multi-event group 102). In such instances, the associator 808 (FIG. 8) associates the new calendar event with the existing calendar event(s) as hierarchical members of the same hierarchical multi-event group (block 1014). For example, the associator 808 may associate the child event 108a as a child of the parent event 106 so that the child event 108a and the parent event 106 are part of the same hierarchical multi-event group 102. Alternatively, if the electronic device 604 first has the child event 108a stored therein and receives the parent event 106 as the new calendar event at block 1002, the associator 808 associates the new parent event 106 as a parent of the child event 108a, resulting in both events 106 and 108a being part of the same hierarchical multi-event group 102.

The processor 902 determines whether it should expand a view of the hierarchical multi-event group 102 (block 1016). For example, the user input interface 802 (FIG. 8) may receive an input indicating selection of the GUI expand control 112 (FIG. 1) to view an expanded view of the hierarchical multi-event group 102 such as one or more of the views shown in FIGS. 2-5. If the processor 902 determines that it should not expand a view of the hierarchical multi-event group 102, control advances to block 1022 (FIG. 10B). Otherwise, if the processor 902 determines that it should expand a view of the hierarchical multi-event group 102, the metadata interface 804 retrieves date/time information, description information, location information, and/or other event information of child event(s) to be displayed (block 1018). For example, if the received input indicates user selection of the GUI expand control 112 of the hierarchical multi-event group 102, the metadata interface 804 retrieves event information for displaying the child events 108a-b. The processor 902 displays or otherwise presents the parent event 106 and the related child event(s) 108a-b on the same calendar view 100 (block 1020) as an expanded view of the hierarchical multi-event group 102 on, for example, the display 910 (FIG. 9).

The processor 902 determines whether it has received an input regarding a user selection to create a recurrence of a first hierarchical multi-event group (block 1022). For example, a user may request to create the recurrence 702 (FIG. 7) of the hierarchical multi-event group 102. If the processor 902 has received a user request to create a recurrence, the recurrence generator 810 (FIG. 8) creates a second hierarchical multi-event group as a recurrence of the first hierarchical multi-event group (block 1024). For example, the recurrence generator 810 may create the recurrence 702 (e.g., the second hierarchical multi-event group) at the second date location of August 6^{th} and 7^{th} as shown in FIG. 7 based on the hierarchical multi-event group 102 (e.g., the first hierarchical multi-event group), which is at the date location of July 1^{st} and 2^{nd}. To create the recurrence, the recurrence generator 810 stores copies of the calendar events in the second hierarchical multi-event group from calendar events in the first hierarchical multi-event group (block 1026). For example, in the illustrated example of FIG. 7, the recurrence generator 810 generates copies of the events 106, 108a-b, and 110a-d from the hierarchical multi-event group 102 as recurrence events 706, 708a-b, and 710a-d of FIG. 7, and stores the recurrence events 706, 708a-b, and 710a-d in association with the recurrence 702. In this manner, a user need not manually make recurring instances of each hierarchical event of the hierarchical multi-event group 102 to make the recurrence 702. Instead, the recurrence generator 810 makes the copies including copying over event information for each calendar event of the hierarchical multi-event group 102. After storing copies of the calendar events at block 1026, or if the user input interface 802 determines that it did not receive a user request to create a recurrence, the example process of FIGS. 10A and 10B ends.

Although certain methods, apparatus, and articles of manufacture have been described herein, the scope of coverage of the following claims is not limited thereto. To the contrary, this disclosure covers all methods, apparatus, and articles of manufacture fairly falling within the scope of the appended claims either literally or under the doctrine of equivalents.

1. A method to organize calendar events, the method comprising:
associating a second calendar event with a first calendar event as a hierarchical child of the first calendar event; and
displaying the first and second calendar events at date and time locations on the same calendar view of a calendar program.

2. The method as defined in claim 1, wherein the associating of the second calendar event with the first calendar event is performed after receiving the second calendar event at an electronic device and determining that the second calendar event includes information indicating it is the hierarchical child of the first calendar event.

3. The method as defined in claim 2, wherein the electronic device receives the second calendar event via a synchronization process with a server or via an electronic message.

4. The method as defined in claim 1, wherein the displaying of the first and second calendar events is in response to receipt of an input indicating a user selection of an expand control on the first calendar event.

5. The method as defined in claim 4, further comprising, in response to receipt of the input indicating the user selection of the expand control, retrieving at least one of time information or a description of the second calendar event from the second calendar event.

6. The method as defined in claim 1, wherein the first and second calendar events are a first hierarchal group, and the method further comprises generating a second hierarchical group as a recurrence of the first hierarchical group at a second date location different from the date location of the first and second calendar events, the second hierarchical group having a third calendar event corresponding to the first calendar event of the first hierarchical group, and a fourth calendar event corresponding to the second calendar event of the first hierarchical group.

7. The method as defined in claim 6, wherein the generating of the second hierarchical group is in response to receipt of an input indicating a user selection of a user interface control to create a second instance of the first hierarchical group.

8. A method to organize calendar events, the method comprising:
retrieving first information from a first field of a first calendar event;
associating the first calendar event with a second calendar event as a hierarchical child of the second calendar event based on the first information matching second information from a second field of the second calendar event.

9. The method as defined in claim 8, further comprising, before retrieving the first information from the first field, receiving the first calendar event at a calendar program of an electronic device during a synchronization event with a server.

10. The method as defined in claim 8, further comprising, before retrieving the first information from the first field, receiving the first calendar event at an electronic device via an electronic message.

11. The method as defined in claim 8, wherein the first information is in at least one of metadata or a first header of the first calendar event.

12. A tangible computer readable storage medium comprising instructions that, when executed, cause a machine to perform the method of claim 8.

13. An apparatus to organize calendar events, the apparatus comprising:
a processor configured to:
associate a second calendar event with a first calendar event as a hierarchical child of the first calendar event; and
display the first and second calendar events at date and time locations on the same calendar view of a calendar program.

14. The apparatus as defined in claim 13, wherein the processor is to associate the second calendar event with the first calendar event after receiving the second calendar event at an electronic device, the second calendar event including information indicating it is the hierarchical child of the first calendar event.

15. The apparatus as defined in claim 14, wherein the electronic device receives the second calendar event via a synchronization process with a server or via an electronic message.

16. The apparatus as defined in claim 14, wherein the electronic device is a mobile telephone.

17. The apparatus as defined in claim 13, wherein the processor is to display the first and second calendar events in response to receipt of an input indicating a user selection of a user interface expand control on the first calendar event.

18. The apparatus as defined in claim 17, wherein the processor is further to retrieve at least one of time information or a description of the second calendar event from the second calendar event in response to receipt of the input indicating the user selection of the user interface expand control.

19. The apparatus as defined in claim 13, wherein the first and second calendar events are a first hierarchal group, and wherein the processor is further configured to generate a second hierarchical group as a recurrence of the first hierarchical group at a second date location different from the date location of the first and second calendar events, the second hierarchical group having a third calendar event corresponding to the first calendar event of the first hierarchical group, and a fourth calendar event corresponding to the second calendar event of the first hierarchical group.

20. The apparatus as defined in claim 19, wherein the processor is to generate the second hierarchical group in response to a user selecting a user interface control to create a second instance of the first hierarchical group.
